(19) United States
(12) Patent Application Publication
(10) Pub. No.: US 2007/0183265 A1
(43) Pub. Date: Aug. 9, 2007

(54) Face of the man on the moon

(76) Inventor: Jose V. Lim, Fort Lee, NJ (US)

Correspondence Address: JOSE V. LIM, Apt 3-H, 2077 Center Avenue, Fort Lee, NJ, 07024, US

(21) Appl. No.: 11/348,165

(22) Filed: Feb. 6, 2006

(51) Int. Cl. G04B 19/26

(52) U.S. Cl. 368/15

(57) ABSTRACT

The present invention and discovery which is evidence by The Face of The Man on the Moon relates and pertains to world peace, unity and friendship of all generations on our planet. He, The Man on the Moon, is the One and Only and the vital icon, emblem and symbol that provides leadership and should provide a foundation and a guiding force for all generations towards permanent world peace, unity and friendship forever on our planet. The magnitude of HIM. The Man on the Moon, is an influence to all generations and will be enormous, outstanding and paramount wherever one resides on this planet. The impact, the goodness and the benefit of this new epiphany to humanity in solving the problem of world peace, unity and friendship will be absolutely wonderful. That is why this new image, invention and discovery is profound, remarkably unique and an exception—a case to which a rule, general principle, a law, etc. does not apply. What is the most important point thus far? Is it not world peace, unity, friendship and happiness that we ultimately desire for the peoples of all generations?

The different photographs of the moon are the only practicable medium for illustrating the claimed invention. (see 37 CFR 1.84 (b) Photographs, (1)). Photo shot of The Moon with The Face of The Man or The Human Face is better than a drawing.

By drawing: people would think that the artist makes, modifies and reworks to look like the face of a man or a human face. Therefore, the originality of the object, which is a part of the moon, is much better in this case.

### BACKGROUND OF THE INVENTION

The present invention and discovery which is evidence by the new image of The Face of The Man on the Moon relates and pertains to world peace, unity and friendship among the peoples of all generations on our planet Earth.

Mankind of this planet needs someone, who will help and guide them towards world peace, unity and friendship.

Currently, there are numerous misunderstandings among human beings—mistrust, fighting and eventually killing are becoming commonplace, etc.

Therefore, HE, The Man on the Moon, shall be a solution to our dilemma; which is, of course, the quest of world peace, unity and understanding

### BRIEF SUMMARY OF THE INVENTION

### The Face of the Man on the Moon

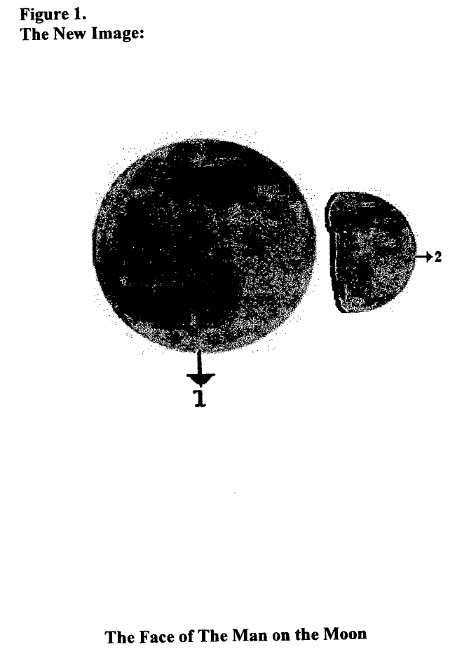

The Moon 1 with the visibility of The Face of The Man on the Moon 2 seen by our naked eyes with creative ability of our vision become a new image, invention and discovery, as shown and described on FIG. 1.

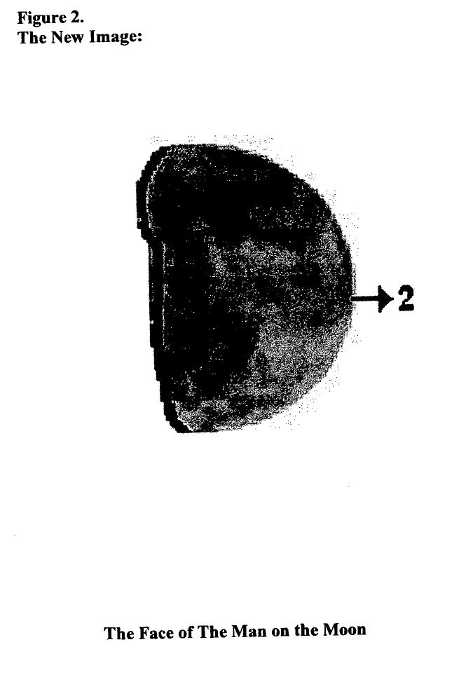

The visibility of The Face of The Man on the Moon 2 seen by our naked eyes from The Moon 1 become a new image, invention and discovery, shown and described on FIG. 1 and FIG. 2;

The Man on the Moon 2 that has identifies, comprehends and sequesters on The Moon by solid, heavy and lead line place across of it become a new image, invention and discovery.

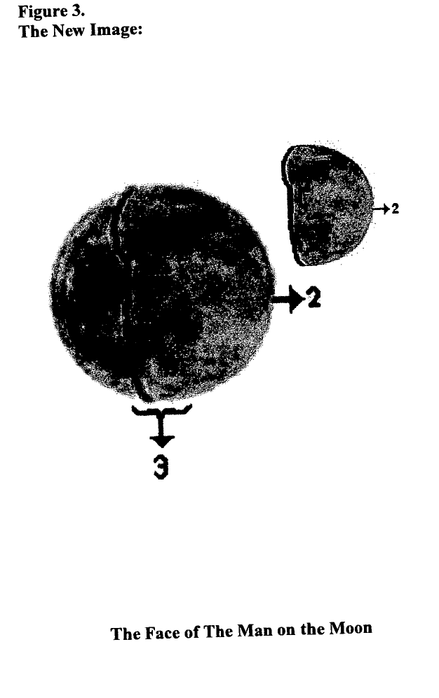

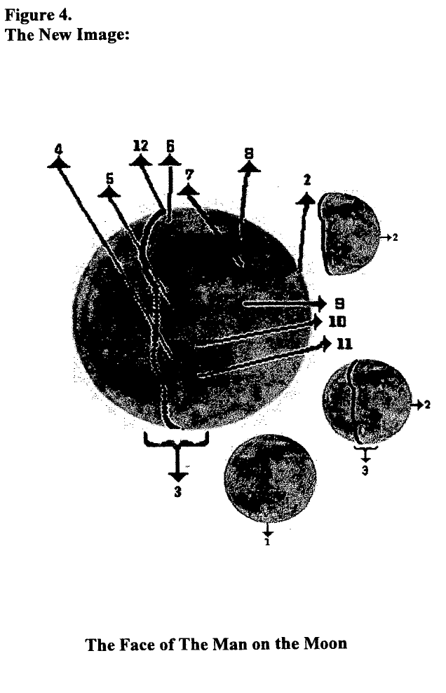

The Moon 1 that is divided into two parts (i.e., The Man on the Moon 2 and the other sides of it) by heavy, solid and lead line placed across of it 3 or The Face of The Man on the Moon 2 that have comprehend, identify and sequester on The Moon 1 with mark of solid, heavy and lead line(s) placed across of it 3 become a new image that has been invented and discovered, as shown and described on FIG. 2, FIG. 3 and FIG. 4.

The Moon 1 with the description of different parts of human face 13 become a new image, invention and discovery, as shown and described on FIG. 4;

This new invention and discovery which is evidence by a new image is not an abstract idea but HE, The Man on the Moon 2, is visible, concrete and a practical object that is patentable subject matter.

### THE OBJECT OF THE INVENTION

He, The Man on the Moon 2, is the One and Only and the most vital icon, emblem and symbol that provides leadership and should provide a foundation and a guiding force for all peoples of all generations towards permanent world peace, unity and friendship forever to our planet Earth.

The magnitude of HIM, The Man on the Moon 2, is an influence to all generations and will be enormous, outstanding and paramount wherever one resides on this planet. The impact, the goodness and the benefit of this new epiphany to humanity in solving the problem of world peace, unity and friendship will be absolutely wonderful—this is what we need so badly and is so important to mankind. This is the essential ingredient in the recipe for world peace.

This invention and discovery which is evidence by The Man on the Moon 2 shall be so vital to solution nowadays and in the future towards permanent world peace, unity and for friendship among the peoples of all generations than ever before.

### DISCLOSURE OF SPECIFICATIONS AND PHOTOGRAPHS

### Description of Multiple Embodiments of the Pictures

Multiple Embodiments: All photographs have a single concept and their appearance and shape are similar and the same, as shown and described.

FIG. 1 is a front elevational view of surface pattern applied to:
The Moon 1 with the visibility of The Face of The Man on the Moon 2 seen by our naked eyes become a new image, invention and discovery.
The Face of The Man on the Moon 2 that is visible to our naked eyes all the year round whether apogee or perigee, wherever we are, around the world become a new image, invention and discovery.
FIG. 1 is also the combination of The Moon 1 and The Face of The Man on the Moon 2, as shown and described.

FIG. 2 is a front elevational view of surface pattern applied to:
The visibility of The Face of The Man on the Moon 2 from The Moon 1 on FIG. 1 and/or by viewing and analyzing different photographs of the moon in order to comprehend, identify and sequester The Face of The Man on the Moon 2 from The Moon 1 by solid, heavy and lead line placed across of it—both of them has a single concept and their appearance and shape are similar and the same, become a new image, invention and discovery.

FIG. 3 Alternate Picture to FIG. 1 is a front elevational view of surface pattern applied to The Moon 1 with a mark of solid, heavy and lead line placed across of it 3 that has comprehend, identify and sequester The Face of The Man on the Moon 2 on The Moon 1 become a image, invention and discovery, as shown and described.
FIG. 3 is also the combination of The Moon 1 with a mark of solid, heavy and lead line across of it 3 and The Face of The Man on the Moon 2, as shown and described.

FIG. 4 Alternate Picture to FIG. 3 is a front elevational view of surface pattern applied to The Face of The Man on the Moon 2 that have recognize, figure out and sequester from The Moon 1 by solid, heavy and lead line placed across of it 3 with the description of different parts of Human Face on the moon 13 become an image, invention and discovery, as shown and described.
The description of different parts of human face that have figure out, recognize and identify on The Face of The Man on the Moon 2 are: the mouth 4, the nose 5. the forehead 6, the eye 7. the eyebrow 8, the whole face 2, the cheek 9, upper lip 10, etc., not a part of the human body is a Cigar 11, and the mark of solid, heavy and lead line placed across 12 the Moon 1, The Moon 1 that is divided into two parts (i.e., The Face of the Man on the Moon 2 and the other sides) by solid, heavy and lead line placed across of it 3 and The whole face 2 or The Face of the Man on the Moon 2 with the description of different parts of Human Face 13.
FIG. 4 is also the combination of The Face of the Man on the Moon 2 with the descriptions of different part of human face 13. The Moon 1 and The Face of The Man on the Moon 2, as shown and described.

These new images, inventions and discoveries apply, utilize and represent the icons, the emblems and/or the symbol for friendship, peace and unity among all peoples of all generations to our planet Earth.

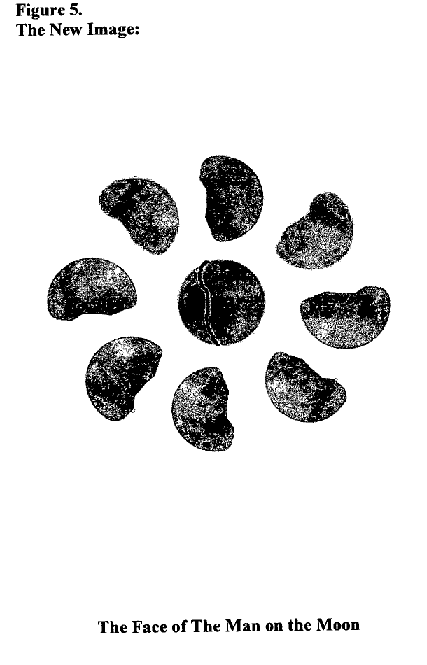

FIG. 5 is a front elevational view of surface pattern applied to the combination of The Faces of a Man on the Moon 2 and The Moon 1 with mark of solid, heavy and lead line placed across of it 3.
The different position of The Faces of The Man on the Moon 2 as it rises, sets and rises again.

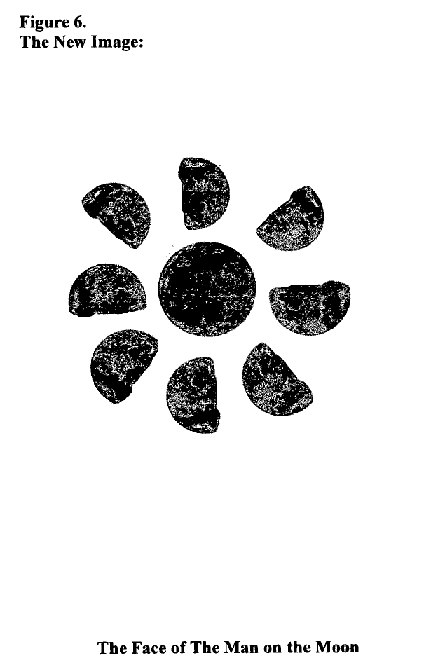

FIG. 6 Alternate Picture to FIG. 5 is a front elevational view of surface pattern applied to the combination of The Faces of The Man on the Moon 2 and The Moon 1.
The different position of The Faces of The Man on the Moon 2 as it rises, sets and rises again.

Any Figure from 1 to 4 and/or any combinations between FIG. 1 to FIG. 4 applied, utilized and represented the icons, the emblems and/or the symbol for friendship, peace and unity among all peoples of all generations to our planet Earth, as shown and described on FIG. 1, FIG. 3, FIG. 4, FIG. 5 and FIG. 6.

### DETAILED DESCRIPTION OF THE INVENTION

Setting Apart the Face of the Man on the Moon from the Moon Itself

To see the real, true, accurate and actual “Face of the Man on the Moon” is achieved by observing, peering and watching the full moon above the horizon or at moonrise with our naked eyes and/or by viewing and analyzing different photographs of the moon in order to comprehend, identify and sequester The Face of the Man on the Moon by solid, heavy and lead line(s) place across it, both of them have a single concept and their appearance and shape are similar and the same.

It would better to see, peer and watch the full moon with our naked eyes especially when above the horizon or at moonrise. All we need is our eyes. We always see the same side of the moon that faces the Earth—the side is The Face of The Man on the Moon appears large enough to our naked eyes all year around, whether apogee or perigee, wherever we are, around the world.

The Moon with the visibility of The Face of the Man on the Moon seen by out naked eyes become a new image, invention and discovery, as shown and described on FIG. 1.

The visibility of The Face of the Man on the Moon which is seen by our naked eyes on the moon with creative ability of our vision and/or by analysis and observation of different photographs of the moon in order to comprehend, identify and sequester The Face of the Man on the Moon by solid, heavy and lead line place across of it, both of them has a single concept and their appearance and shape are similar and the same, become a new image, invention and discovery, as shown and described on FIG. 2. Also shown and described on FIGS. 1, 3, 4, 5 and 6.

The Moon with a mark of solid, heavy and lead line(s) placed across it engender comprehend, identify and sequester the Face of the Man on the Moon on the moon as a new image, invention and discovery, as shown and described on FIG. 3.

Also shown and described on FIG. 4 and FIG. 5.

The Face of the Man on the Moon with the descriptions of different part of human face become new image, invention and discovery, as shown and described on FIG. 4.

The visibility of The Human Face on the Moon or The Man on the Moon and/or The Face of the Man on the Moon that has been identified and sequestered on the moon by solid, heavy and lead line(s) placed across of it, as shown and described on FIG. 1, FIG. 2, FIG. 3, FIG. 4, FIG. 5 and FIG. 6 have a universally recognized conventional meaning, purposes and aim for peace, unity and friendship and are generally accepted in the photography.

Any Figure from 1 to 4 and/or any combinations between FIG. 1 to FIG. 3 applied, utilized and represented the icons, the emblems and/or the symbol for friendship, peace and unity among the peoples of all generations to our planet Earth, as shown and described on FIG. 1, FIG. 3, FIG. 4, FIG. 5 and FIG. 6.

Any combinations of the moon and/or the moon with mark of solid, heavy and lead line(s) placed across it and/or The Face(s) of the Man on the Moon as shown and described here, they can effectively represent the character and contour of most surfaces patterns

This new invention and discovery which is evidence by a New Image is not an abstract idea but HE, The Face of the Man on the Moon, is visible, concrete and a practical object that is patentable subject matter.

Mankind always knows the spectacular, enormous and tremendously gigantic figure of The Human Face on the Moon—that can be seen by our naked eyes wherever we resides around the world all year around, whether apogee or perigee

He, The Man on the Moon, is the One and Only and the most vital icon, emblem and symbol that provides leadership and should provide a foundation and a guiding force for all peoples of all generations towards permanent world peace, unity and friendship forever to our planet Earth.

This is first time, HE, The Man on the Moon, will be known to humanity.

Perhaps, HE, The Face of the Human Being on the Moon, has been there ever since the formation of our solar system.

HE, The Man on The Moon, is the most significant, outstanding and unique icon, emblem and symbol for peace, unity and friendship those human beings will ever know.

The magnitude of HIM, The Man on The Moon, is an influence to all generations and will be enormous, outstanding and paramount wherever one resides on this planet. The impact, the goodness and the benefit of this new epiphany to humanity in solving the problem of world peace, unity and friendship will be absolutely wonderful—this is what we need so badly and is so important to mankind. This is the essential ingredient in the recipe for world peace.

That is why this new image, invention and discovery is profound, remarkably unique and an exception—a case to which a rule, general principle, a law, etc. does not apply.

What is the most important point thus far?

Is it not world peace, unity, friendship and happiness we ultimately desire for the peoples of all generations?

What is I claimed is:

1. The present invention and discovery which is evidence by The Face of The Man on the Moon relates and pertains to world peace, unity and friendship of all generations on our planet. He, The Man on the Moon, is the One and Only and the vital icon, emblem and symbol that provides leadership and should provide a foundation and a guiding force for all generations towards permanent world peace, unity and friendship forever on our planet. The magnitude of HIM. The Man on the Moon, is an influence to all generations and will be enormous, outstanding and paramount wherever one resides on this planet. The impact, the goodness and the benefit of this new epiphany to humanity in solving the problem of world peace, unity and friendship will be absolutely wonderful. That is why this new image, invention and discovery is profound, remarkably unique and an exception—a case to which a rule, general principle, a law, etc. does not apply. What is the most important point thus far? Is it not world peace, unity, friendship and happiness we ultimately desire for the peoples of all generations?

2. The Face of The Man on the Moon as defined in claim 1 to see the real, true, accurate and actual “Face of The Man on the Moon” is achieved by observing, peering and watching the full moon above the horizon or at moonrise with our naked eyes with creative ability of our vision and/or by viewing and analyzing different photographs of the moon in order to comprehend, identify and sequester The Face of the Man on the moon by solid, heavy and lead line(s) placed across of it.
Mankind always knows the spectacular, enormous and tremendously gigantic figure of The Human Face on the Moon all year round whether apogee or perigee, this is extremely huge—and can be seen by our naked eyes wherever we are, around the world.
Perhaps, HE, The Man on the Moon, has been there ever since the formation of our solar system.
This is first time HE, The Face of The Man on the Moon, will be known to humanity, as illustrated, shown and described on FIGS. 1, 2, 3, 4, 5 and 6.

3. The Moon with the visibility of The Face of The Man on the Moon seen by our naked eyes becomes a new image, invention and discovery, as shown and described on FIG. 1.

4. The visibility of The Face of The Man on the Moon seen by our naked eyes all year round whether apogee or perigee, wherever we are, around the world and/or The Face of The Man on the Moon that have comprehend, identify and sequester from the moon by solid, heavy and lead line(s) placed across of it become a new image that has been invented and discovered, as shown and described on FIG. 2. Also shown and described on FIGS. 1, 3, 4, 5 and 6.

5. The Moon with a mark of solid, heavy and lead line placed across of it engender comprehend, identify and sequester The Face of The Man on the Moon on the moon as a new image, invention and discovery, as shown and described on FIG. 3. Also shown and described on FIG. 4 and FIG. 5.

6. The Man on The Moon with the description of different parts of human face become a new image, invention and discovery, as shown and described on FIG. 4.

7. HE, The Face of The Man on the Moon, is the most significant, unique and outstanding icon, emblem and symbol for peace, unity and friendship that all human beings will ever know
The new invented, discovered and evidenced by a new image applying, utilizing and representing the icons, the emblems and the symbols are appropriate, adequate and acceptable. The symbols, the emblems and the icons will serve its aimed, purposed and used for peace, unity and friendship among the peoples of all generations to our planet Earth.

8. This new invention and discovery of The Face of The Man on the Moon shall be so vital to solution nowadays and in the future towards permanent world peace, unity and for friendship among the peoples of all generations than ever before.

9. This new invention, discovery and image (i.e., The Face of The Man on The Moon) will open the way to a new meaning, a new approach and a new concept of life among the peoples of the entire world, the present and the future generations—a new frontier and era of friendship, peace and unity to the peoples of all generations to our planet Earth. This will lead us to change and advance our civilization.

10. The exchange of ideas and information among the peoples in the world regarding The Human Face on the Moon will lead, help and bring us closer together and united as one people working and living together for friendship, peace and unity.

11. After the release of this new information of The Face of the Man on the Moon to the public, perhaps, an enormous explosion of news of the new information will be around the world—on the newspapers, magazines, books, radios, television, tremendous photo shot of full moon in different parts around the world through many, many and many websites, reaching out each other's about the new information through e-mails, etc. for many, many and many years to come.

12. Then and only then, the longevity of the information about The Face of The Man on the Moon will help and lead us toward a new frontier and era of permanent world peace, unity and friendship among the peoples of all generations to our planet Earth.
Furthermore, this will change us and shall have better understanding to each other that will bring and live us closer together living as one people . . . helping others in the opportunity of better standard of living and quality of life.

13. The new invention and discovery which is evidenced by a New Image is not an abstract idea but HE, The Man on the Moon, is visible, concrete, and a practical object and is patentable subject matter.

14. The Face of The Man on the Moon as claimed in claims 3, 4. 5 and/or 6 wherein any from 3 to 6 and/or any combinations between 3 to 6 applies, utilizes and represents the icons, the emblems and the symbols for peace, unity and friendship among the peoples of all generations to our planet Earth, as shown and described on FIG. 1, FIG. 2, FIG. 3, FIG. 4, FIG. 5 and FIG. 6.
